(19) United States
(12) Patent Application Publication
(10) Pub. No.: US 2025/0196381 A1
(43) Pub. Date: Jun. 19, 2025

(54) Razor with Rear Loading Razor Blades

(71) Applicant: Leaf Shave Company, Pittsburg, PA (US)

(72) Inventor: Adam J. Hahn, Pittsburgh, PA (US)

(21) Appl. No.: 18/987,729

(22) Filed: Dec. 19, 2024

Related U.S. Application Data
(60) Provisional application No. 63/611,887, filed on Dec. 19, 2023.

(51) Int. Cl. B26B 21/22; B26B 21/40; B26B 21/52; B26B 21/56

(52) U.S. Cl. CPC B26B 21/22; B26B 21/4018; B26B 21/521; B26B 21/565; B26B 21/4043; B26B 21/522

(57) ABSTRACT

In accordance with one aspect of the disclosure, a shaving razor, having: a handle having a distal end and a proximal end, the distal end having at least one biased arm configured to couple to a cartridge; the cartridge coupled to the biased arms, the cartridge having a first cartridge arm and a second cartridge arm separated by at least one blade retainer configured to releasably fix at least one shaving razor blade thereto; the at least one blade retainer having a blade handling surface having a first side portion that defines a plane and a second side portion configured to receive the at least one shaving razor blade; and where the cartridge is configured to expose a cutting edge of the at least one shaving razor blade past the first side portion.

### CROSS-REFERENCE TO RELATED APPLICATIONS

The present application claims priority to and the benefit of U.S. Provisional Application No. 63/611,887, entitled “Razor with Rear Loading Razor Blades”, filed Dec. 19, 2023, the disclosure of which is hereby incorporated by reference in its entirety.

### BACKGROUND OF THE INVENTION

### Field of the Invention

This disclosure relates generally to razors and, more particularly, to a razor with replaceable blades.

### Description of Related Art

Razors have become ubiquitous and are used by both men and women for their personal shaving needs. Straight-blade razors, which are made of high carbon or stainless steel, exemplify the early modern popular style of shaving implements. Current shaving implements commonly consist of a handle and disposable razor cartridge. These razor cartridges can be used for many shaving sessions over a period of time, but must be thrown out after they become dull from use. The process of recycling these razor cartridges is tedious, as there are multiple plastic and metal components that make up the traditional razor cartridge.

Disposable razor blades replaced the straight edge in popularity in the early part of the twentieth century. The disposability of blades after limited use was made popular and economical by the arrival of blades made of low-cost thin steel, thereby eliminating the need for stropping or honing. The safety feature of these razors, protecting the user from all but the very edge of the blade, appealed to the user. The orientation of the handle and the blade required the user to develop the proper technique to achieve an optimal shave. The next evolution combined the safety of small, thin blades exposed only at the edge with the proper angle-of-attack and a pivoting head to adjust to the contours of the body. The disposable razor embodied the ease and simplicity of shaving, sacrificing longevity of product by providing disposable blades with limited life. This incarnation of men's and women's personal shavers remains the most popular and widely used, contributing a sizeable global economic impact.

While the convenience and ease of use of current disposable razor cartridge technology is attractive to users, alternative razors using partially replaceable blades have continued to evolve. However, current replaceable blades still are problematic and unsafe when being replaced. Current replaceable blades point the exposed blade toward the user when replacing and include awkward components which make replacing blades difficult.

Many of the current disposable razors end up in landfills or as trash impacting the global environment. Many of these disposed razor cartridges, however, include components that do not need to be disposed of as they are still useable. This leads to a tremendous amount of unnecessary waste, as only the dull razor blade needs to be replaced in the razor cartridge. Many of the components are replaceable, but are not easily removable to encourage or allow replacement. Therefore, there is an ongoing need to reduce the amount of waste contributed by useable components of razor cartridges and a need for easily replaceable components, which is accomplished by the razor cartridge described herein.

### SUMMARY OF THE INVENTION

In view of the foregoing, a need exists for a razor cartridge including a replaceable razor blade that provides an effective method of replacing the razor blades. A further need exists for a razor including an adjustable frame that provides a secure and easily removable cover for holding the razor blades.

In accordance with one aspect of the disclosure, a shaving razor, having: a handle having a distal end and a proximal end, the distal end having at least one biased arm configured to couple to a cartridge; the cartridge coupled to the biased arms, the cartridge having a first cartridge arm and a second cartridge arm separated by at least one blade retainer configured to releasably fix at least one shaving razor blade thereto; the at least one blade retainer having a blade handling surface having a first side portion that defines a plane and a second side portion configured to receive the at least one shaving razor blade; and where the cartridge is configured to expose a cutting edge of the at least one shaving razor blade past the first side portion.

In accordance with another aspect of the disclosure, the shaving razor includes the blade handling surface is configured to bias the razor blade upon installation.

In accordance with another aspect of the disclosure, the shaving razor includes the blade retainer is configured to removably couple multiple razor blades.

In accordance with another aspect of the disclosure, the shaving razor includes the blade handling surface is configured to bias the razor blades upon installation.

In accordance with another aspect of the disclosure, the shaving razor includes the blade handling surface is configured to expose a non-cutting surface of the razor blade.

In accordance with another aspect of the disclosure, the shaving razor includes the razor handle having a distal end and a proximal end, the distal end having two biased arms configured to couple to the cartridge.

In accordance with another aspect of the disclosure, the shaving razor includes the cartridge is rotatably coupled to the biased arms.

In accordance with another aspect of the disclosure, the shaving razor includes a handle; a cartridge coupled to the handle, the cartridge having blade corner guards, a first cartridge arm, and a second cartridge arm separated by a blade retainer configured to releasably fix at least one shaving razor blade thereto; the blade retainer including a blade handling surface and a contact surface that defines a first plane, where a first side portion of the cartridge along the first plane is configured to expose a cutting edge of the at least one shaving razor blade past the plane, a second side portion defining a second plane configured to receive the at least one shaving razor blade; and where the blade handling surface contacts the at least one razor blade upon installation and at least one blade corner guard configured to prevent contact with the respective corners of the cutting edge of the shaving razor blade and cutting surface during use.

In accordance with another aspect of the disclosure, the shaving razor includes the blade handling surface is configured to bend the razor blade upon installation.

In accordance with another aspect of the disclosure, the shaving razor includes the blade retainer is configured to removably couple multiple razor blades.

In accordance with another aspect of the disclosure, the shaving razor includes the blade handling surface is configured to bend the razor blades upon installation.

In accordance with another aspect of the disclosure, the shaving razor includes the blade handling surface is configured to expose a non-cutting surface of the razor blade extending through the second plane.

In accordance with another aspect of the disclosure, the shaving razor includes the razor handle including a distal end and a proximal end, the distal end including two biased arms configured to couple to the cartridge.

In accordance with another aspect of the disclosure, the shaving razor includes the cartridge is rotatably coupled to the biased arms.

In accordance with another aspect of the disclosure, a method for installing and removing shaving razor blades in a shaving razor, includes: inserting a razor blade into a receiving end of a shaving razor cartridge; exposing a cutting edge of the razor blade through the shaving razor cartridge; bending the razor blade against a blade handling surface of the shaving razor cartridge to releasably couple the razor blade to the blade handling surface; and removing the razor blade by pulling out the razor blade through the receiving end of the shaving razor cartridge.

In accordance with another aspect of the disclosure, the method for installing and removing shaving razor blades in a shaving razor where the razor blade when bending, snaps against the blade handling surface.

In accordance with another aspect of the disclosure, the method for installing and removing shaving razor blades in a shaving razor further including gripping a non-cutting edge of the razor blade when removing.

In accordance with another aspect of the disclosure, the method for installing and removing shaving razor blades in a shaving razor, using the razor blade until a cutting edge is no longer usable before removing.

In accordance with another aspect of the disclosure, the method for installing and removing shaving razor blades in a shaving razor, further includes inserting a razor blade into a receiving end of a shaving razor cartridge, the cartridge coupled to a handle, the cartridge comprising blade corner guards, a first cartridge arm, and a second cartridge arm separated by a blade retainer configured to releasably fix at least one shaving razor blade thereto; the blade retainer comprising a blade handling surface and a contact surface that defines a first plane, wherein a first side portion of the cartridge along the first plane is configured to expose a cutting edge of the at least one shaving razor blade past the plane, and a second side portion defining a second plane configured to receive the at least one shaving razor blade.

In accordance with another aspect of the disclosure, the method for installing and removing shaving razor blades in a shaving razor, further comprising inserting a second razor blade into the receiving end of the shaving razor cartridge.

Further details and advantages will be understood from the following detailed description read in conjunction with the accompanying drawings.

### BRIEF DESCRIPTION OF THE DRAWINGS

FIG. 1 is a side view of an example embodiment of a razor;

FIG. 2 is a bottom view of an example embodiment of a razor;

FIG. 3 is a top view of an example embodiment of a razor;

FIG. 4 is a bottom view of an example embodiment of a razor cartridge;

FIG. 5 is an isometric view of an example embodiment of a razor cartridge;

FIG. 6 is an isometric section view of an example embodiment of a razor cartridge;

FIG. 7 is a bottom view of an example embodiment of a razor cartridge with razor blades installed;

FIG. 8 is an isometric view of an example embodiment of a razor cartridge with razor blades installed;

FIG. 9 is an isometric section view of an example embodiment of a razor cartridge with razor blades installed;

FIG. 10 is a side section view of an example embodiment of a razor cartridge with razor blades installed; and

FIG. 11 is a side section view of an example embodiment of a razor cartridge with razor blades installed with exemplary planes;

FIG. 12. is an isometric top view of an example embodiment of a razor;

FIG. 13 is a side view of an example embodiment of a razor;

FIG. 14 is a bottom view of an example embodiment of a razor;

FIG. 15 is a top view of an example embodiment of a razor;

FIG. 16 is a top view of an example embodiment of a razor cartridge;

FIG. 17 is an isometric view of an example embodiment of a razor cartridge; and

FIG. 18 is an isometric section view of an example embodiment of a razor cartridge.

### DESCRIPTION OF THE INVENTION

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Embodiments of the present disclosure relate to a partially replaceable styling and grooming razor used for removing unwanted body hair in common, hard-to-reach, or awkward places. Additionally, the razor of these embodiments can be adjusted and used for shaving with a high degree of detail for safety and ornamental shaving. For example, the razor blade in the razor head can be safely replaced and recycled and can be used to groom the eyebrows, moustache, nose, sideburns, scalp, abdomen, bikini area, toes and other parts of the body. Certain embodiments are able to accomplish such effects because of the size and shape of the razor blades in comparison to conventional razor blades, and because the razor design allows for replacement of the razor in the razor head with the cutting edge away from the installer. In some embodiments, the blades are 1 inch, ½ inch, ⅜ inch, ¼ inch, ⅛ inch or any size or range of sizes in between any of these sizes in length, depth, or thickness. The blades may be any common size for a razor blade used, in general, as a shaving razor. Furthermore, in certain embodiments, each of the different size blades or heads can be used as interchangeable razors on the same razor handle, and can have single or multiple cutting edges.

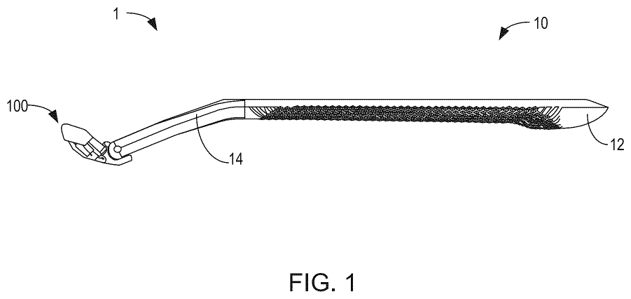

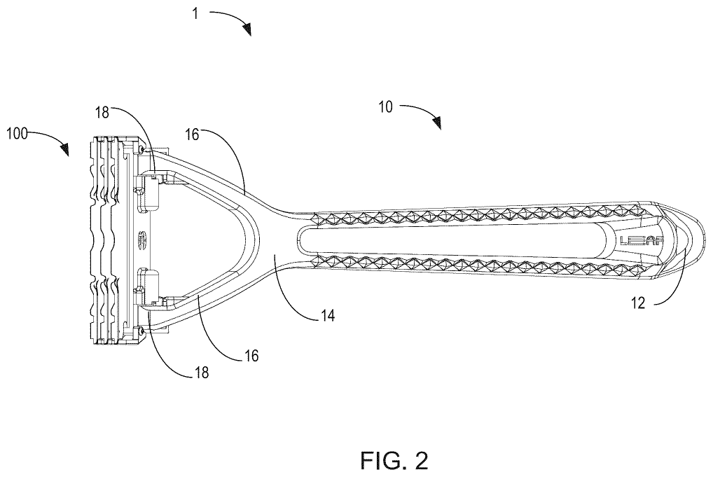

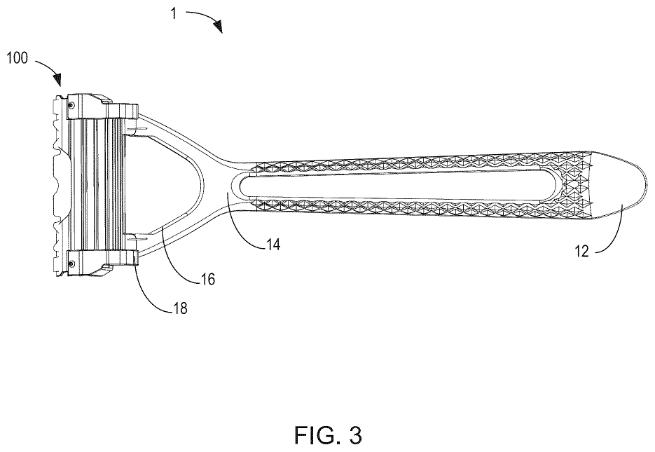

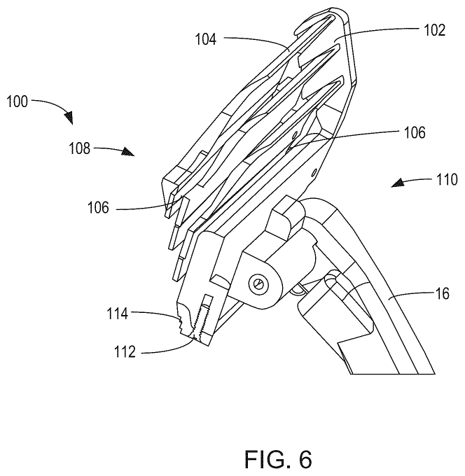

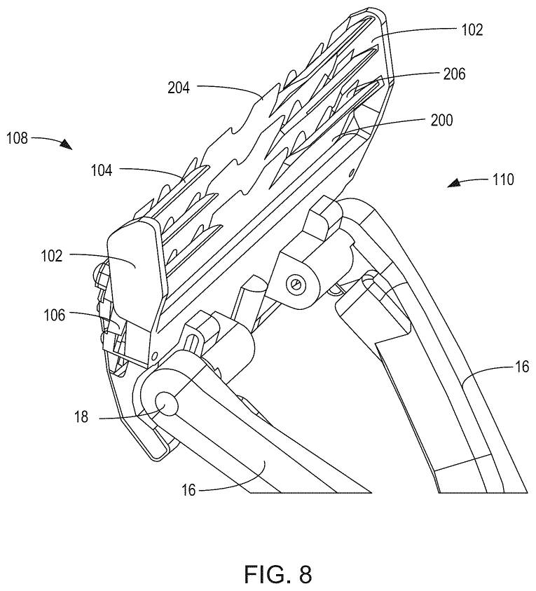

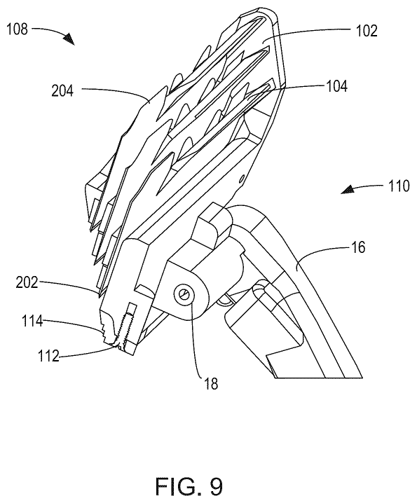

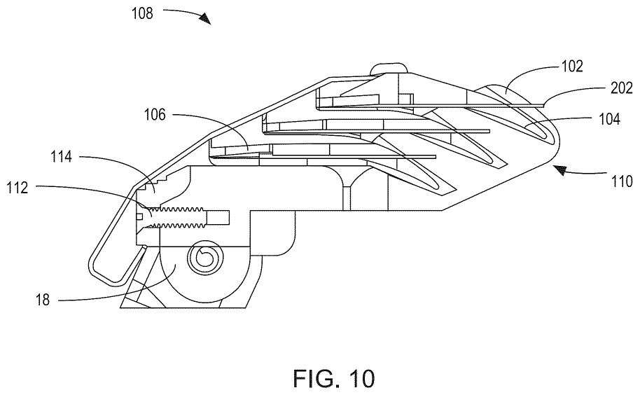

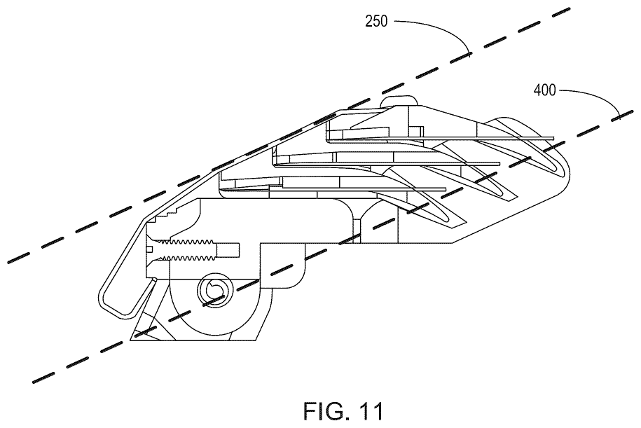

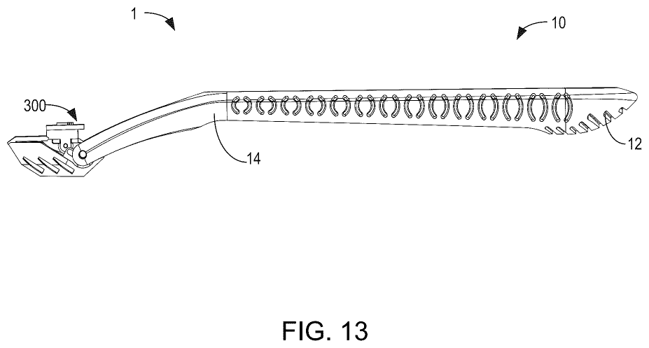

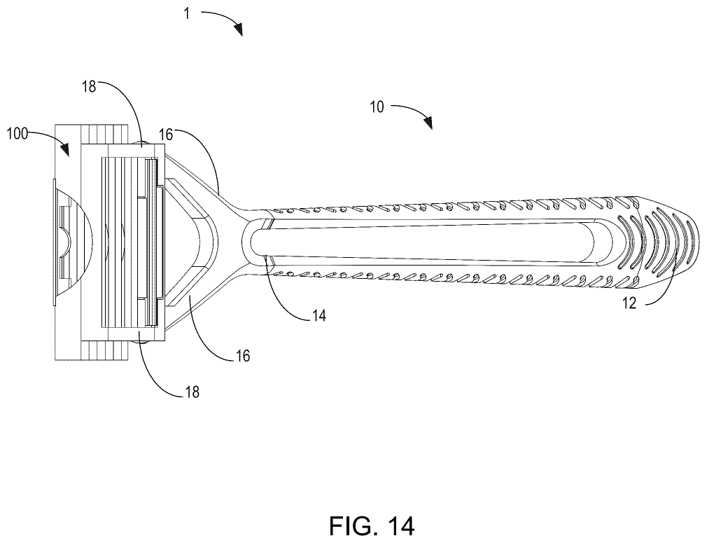

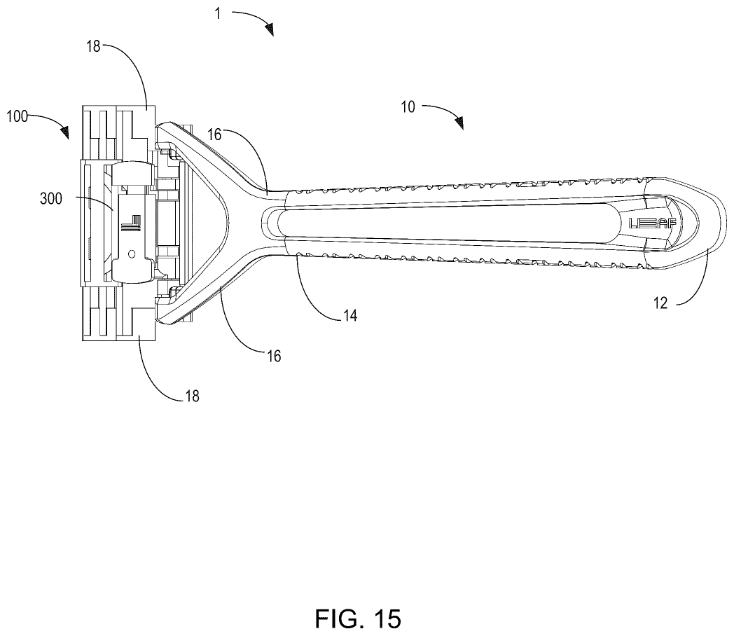

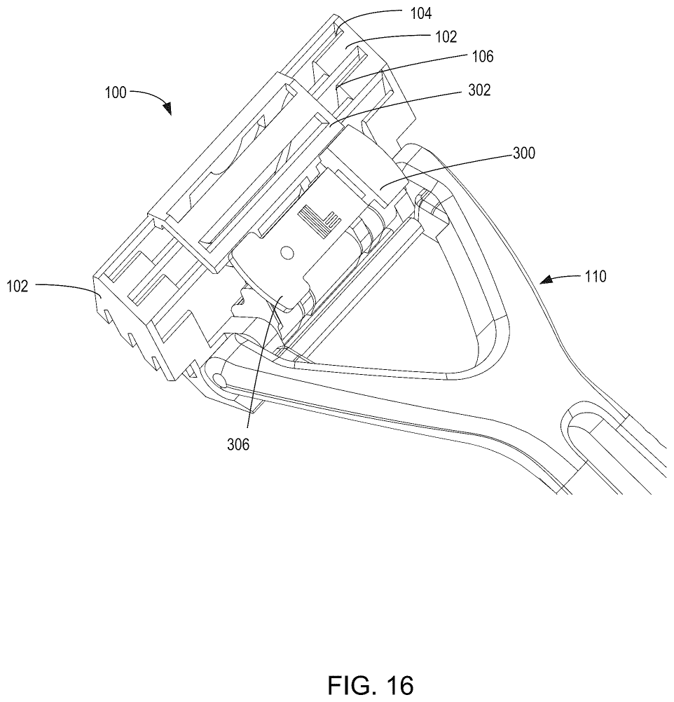

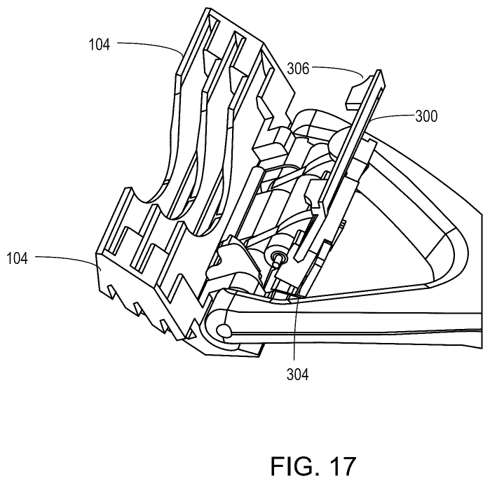

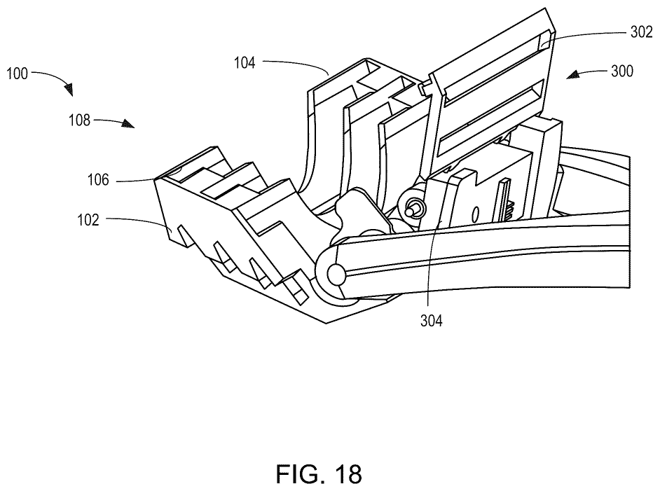

The present disclosure is directed to, in general, a shaving razor and, in particular, a shaving razor with safely replaceable blades. Certain preferred and non-limiting aspects of the components of the razor are illustrated in FIGS. 1-18.

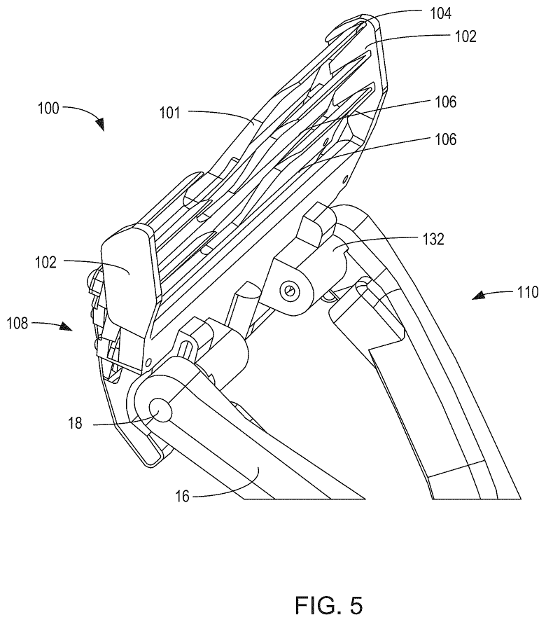

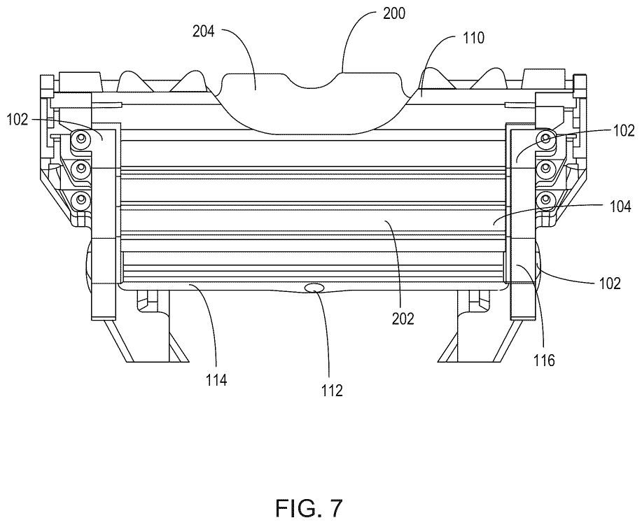

As shown in FIGS. 1-3, an exemplary embodiment of an assembled shaving razor apparatus 1 of the present disclosure is illustrated. The apparatus 1 has a handle 10 with a proximate end 12 for a user to grip and a distal end 14. The handle 10 may include different types of surfaces, including small protrusions, bumps, waves, or indentations, to provide a comforting ergonomic feel when held by an individual and/or to assist the user in gripping the apparatus 1. As shown in a later embodiment, the handle may include a grip texture on the handle 10. The handle 10 may have an elongated aperture therewithin. The distal end 14 of the handle 10 may include two biased arms 16 which extend outward from the distal end 14 of the handle 10. The arms 16 may be symmetrical to one another. There may be a singular arm 16 which connects to the razor cartridge assembly 100. A razor cartridge assembly 100 may be mounted to a distal end 14 of the shaving razor apparatus 1. The razor cartridge assembly 100 may be mounted to the two biased arms 16. The biased arms 16 may also include two connecting portions 18 which may be configured to mount a razor cartridge assembly 100. In one aspect, the razor cartridge assembly 100 may be pivotably or rotationally mounted to the biased arms 16 and relative to the handle 10. The razor cartridge assembly 100 may have rotational mounts 132 which rotationally mount to the connecting portions 18, as shown in the exemplary embodiment of FIG. 5. In another aspect, the razor cartridge assembly 100 may be mounted relative to the handle 10 in a stationary manner. The mounted razor cartridge assembly 100 may be positioned so that a razor blade 200 may be installed and a cutting edge 202 of the razor blade 200 may be exposed to a cutting surface, as shown in the exemplary embodiment of FIG. 7.

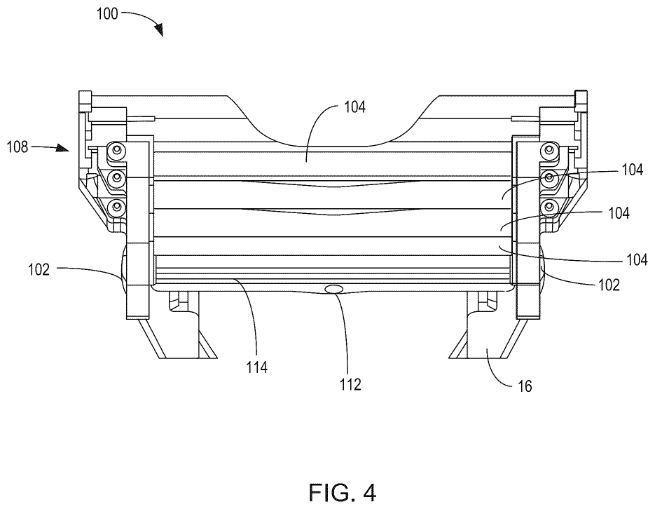

FIGS. 4-6 exemplifies an embodiment of a razor cartridge assembly 100 of the present disclosure. The razor cartridge assembly 100 itself may be substantially rectangular or toroidal in shape. In another aspect, the razor cartridge assembly 100 may be substantially cylindrical in cross-sectional shape. However, it is also contemplated that alternative shapes may be used, such as triangular, oval, square, or trapezoidal. The razor cartridge assembly 100 may include two outer cartridge arms 102 which partially align with the two handle arms 16. The outer cartridge arms 102 may be spaced apart so a commercial razor blade 200 may fit between, however the spacing may be appropriate for any razor blade 200 to fit. The blade retainers 104 may fit between the two cartridge arms 102 as well. The razor cartridge assembly 100 may have at least one blade retainer 104 and blade handle surfaces 106. The razor blade 200 rests on the blade handle surface 106 of the razor cartridge assembly 100, which are configured to retain at least one razor blade 200. The blade handle surface 106 may be located on a first side of the blade retainers 104 or on a second side. The blade handle surface 106 may be magnetic or made of metal, plastic, rubber, or a similar material. The blade handle surface 106 may be configured to aid in coupling the razor blade 200. The blade retainers 104 may be configured to be in a stacked position to expose the cutting edges 202 of multiple installed razor blades 200. The razor cartridge assembly 100 may be configured so that the cutting edge 202 of the razor blades 200 are exposed to cut a surface on an opposite side of the cartridge 100 than the location of the cartridge mount points with the blade handle arms 16.

A screw 112 or another attachment member on the first side 108 of the razor cartridge assembly 100 may be used for installing a preparation strip 114. The preparation strip 114 may be used to pull and align the hair away from the user's skin such that the hair may be cut closer to the skin. The preparation strip 114 may lather shaving cream on a user's skin surface as the razor blade 200 is used to shave the shaving surface. Lathering the shaving cream aids in preparing the shaving surface for a closer shaving. The location of the preparation strip 114 allows for the shaving surface to first contact the preparation strip 114 before being shaved by the razor blade 200. The preparation strip 114 may be made of metal, plastic, rubber, or a similar material. The preparation strip 114 may also act as a guard or be positioned to prevent a user from having the razor blade 200 unintentionally cut the user. In another embodiment, the first side 108 of the razor cartridge assembly 100 is configured and shaped such that the first side 108 will prevent a user from having the razor blade 200 unintentionally cut the user.

As shown in FIGS. 4-11, blade retainers 104 may be configured to mate with respective recesses 206 in shaving razor blades 200 to retain the razor blade 200 within the head 101. The back side 110 of the razor cartridge assembly 100 may be shaped and configured to fit a commercial razor blade 200. In another embodiment, tight tolerances in width between the cartridge arms 102 may allow for a slight tension bias in the razor blade 200 during blade insertion into the razor cartridge assembly 100. This configuration creates a slight tension bias in the razor blade 200 so that the razor blade 200 are held in position within the razor cartridge assembly 100 due to friction created by the tension bias. In another configuration, the blade retainers 104 are shaped and configured to create a slight tension bias in the blades 200 by being curved or shaped and having a curved or shaped blade handling surface 106. The shaped blade retainer 104 is shaped so that the curvature of the blade retainers 104 are located near the back side 110 of the razor cartridge assembly 100. This prevents any curvature or unwanted shape in the cutting edge 202 of the razor blade 200. These configurations may also include that the blade retainers 104 “sandwich” or tension at least one razor blade 200, but preferably multiple blades 200 together with the retainers 104. Advantageously, a user may insert or slide the razor blades 200 from the back side 110 or opposite side of where the cutting edge 202 is exposed. This allows for the razor blades 200 to be inserted and has the razor blade 200 bend slightly so as to bias the razor blade 200 upwards and having the cutting edge 202 be supported from behind. Further, this advantageously allows for friction to hold the razor blades 200 in place after installation and during use. The razor blade 200 may be bent enough to removably fix the razor blade 200 within the cartridge 100 while not altering or interfering with the cutting ability of the razor blade 200.

FIGS. 7-11 exemplify an embodiment of a razor cartridge assembly 100 with razor blades 200 installed of the present disclosure. The razor cartridge assembly 100 may be rotatably coupled to the biased arms 16 with the razor cartridge assembly 100 having both the cutting side and the installation side accessible. In one embodiment, the first cartridge arm 102 and a second cartridge arm 102 are separated by multiple blade retainers 104 which are configured to releasably fix multiple shaving razor blades 200 thereto. The multiple blade retainers 104 may form a ladder-like configuration with blade handling surfaces 106 exposed so that razor blades 200 can be installed and a cutting edge 202 can be exposed. The cartridge 100 may have a first side portion 108 that defines a first plane 250 and a second side portion 110 which defines a second plane 400. Upon installation of the razor blades 200, the cartridge 100 is configured so that cutting edge 202 of the razor blade 200 extends through the cutting plane 250 or the cutting edge 202 is exposed past the cutting plane 250. The razor blade 200 may be bent or biased towards the cutting plane 250 or towards the second plane 400. The shape of the cartridge 100 may be configured to adjust the angle of the cutting plane 250 in reference to the first side 108. This angle is the angle at which the cutting edge 202 is exposed and the alignment of the cutting edge 202 determines the steepness of the exposed cutting edge 202 and aggressiveness of the razor.

Further, upon installation of the razor blades 200, the razor cartridge assembly 100 is configured so that the non-cutting edge of the shaving razor blade 200 extends through the second plane 400 or the gripping portion 204 is exposed. Advantageously, the blade retainers 104 and the blade handling surfaces 106 are ergonomically configured so that upon installation of the blades 200, the non-cutting edge is exposed so that a user may grip the blades 200 to adjust or remove them. The blade handling surfaces 106 and blade retainers 104 are configured as to provide enough biasing force to hold the blades 200 in place, but still leaving enough uncontacted surface of the razor blade 200 to install and remove with ease. In another embodiment, the razor cartridge assembly 100 may include a blade corner guard 116 configured to prevent contact of the corners of the cutting edge 202 of the shaving razor blades 200 and the cutting surface. The blade corner guard 116 may be sized to contact the edge of the razor blade 200 and create the biasing force to maintain the removably fixed nature of the razor blade 200.

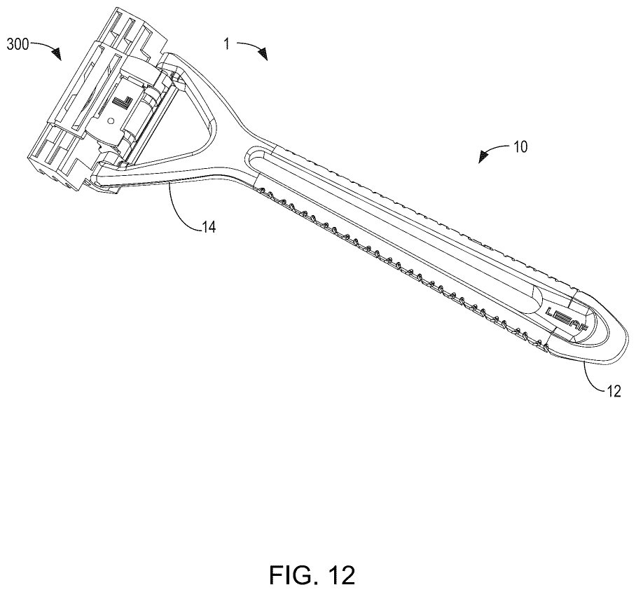

FIGS. 12-18 exemplify another embodiment of a razor cartridge assembly 100. The razor cartridge assembly 100 itself may be substantially rectangular or toroidal in shape. In another aspect, the razor cartridge assembly 100 may be substantially rectangular in cross-sectional shape. The razor cartridge assembly 100 may include two outer cartridge arms 102 integral to one another which partially align with the two handle arms 16. The outer cartridge arms 102 may be spaced apart so a commercial razor blade 200 may fit between, however the spacing may be appropriate for any razor blade 200 to fit. The blade retainers 104 may fit between the two cartridge arms 102 as well. The blade retainers 104 may be integral with the two cartridge arms 102 to form a single structure. The razor cartridge assembly 100 may have at least one blade retainer 104 and blade handle surfaces 106, also integral to the outer cartridge arms 102. The razor blade 200 rests on the blade handle surface 106 of the razor cartridge assembly 100, which are configured to retain at least one razor blade 200. The blade handle surface 106 may be located on a first side of the blade retainers 104 or on a second side. The blade handle surface 106 may be magnetic or made of metal, plastic, rubber, or a similar material. The blade handle surface 106 may be configured to aid in coupling the razor blade 200. The blade retainers 104 may be configured to be in a stacked position to expose the cutting edges 202 of multiple installed razor blades 200. The razor cartridge assembly 100 may be configured so that the cutting edge 202 of the razor blades 200 are exposed to cut a surface on an opposite side of the cartridge 100 than the location of the cartridge mount points with the blade handle arms 16. A blade guard 300 may be rotatably fixed to the back of the razor cartridge assembly 100. The blade guard 300 may protect the back edge of the razor blades 200 by rotatably closing over the back edges. The blade guard 300 may include slots 302 or apertures shaped to receive the recesses 206 of the razors 204 when the blade guard 300 is in the closed position. The blade guard 300 may include a handle 304 to aid in transitioning between a closed and open position. The handle 304 may be included with a spring pin latch which can lock to hold a razor blade 200 within the blade handle surface 106 and unlock when squeezed and rotated to an open position. The blade guard 300 may include a tab 306 for withholding the razor blades 200 or the contacting the at least one blade retainer 104 to hold the razor blades 200. The blade guard 300 may advantageously protect the back edge of the razor blades 200 and prevent the razor blades 200 from unwantedly being removed.

Advantageously, a user may insert or slide the razor blades 200 from the back side or opposite side of where the cutting edge 202 is exposed. This allows for the razor blades 200 to be inserted and has the blade bend slightly so as to upwardly bias the razor blade 200 and having the cutting edge 202 be supported from behind. Further, this advantageously allows for friction to keep the razor blades 200 in place after installation and during use. Advantageously, the blade retainers 104 and the blade handling surfaces 106 are ergonomically configured so that upon installation of the razor blades 200, the non-cutting edge is exposed so that a user may grip the razor blades 200 to adjust or remove them. Other advantages and features of the invention will be apparent from the following description of the particular embodiments and from the claims.

While aspects of a razor are shown in the accompanying figures and described hereinabove in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

What is claimed is:

1. A shaving razor, comprising:
a handle comprising a distal end and a proximal end, the distal end comprising at least one biased arm configured to couple to a cartridge;
the cartridge coupled to the biased arms, the cartridge comprising a first cartridge arm and a second cartridge arm separated by at least one blade retainer configured to releasably fix at least one shaving razor blade thereto;
the at least one blade retainer comprising a blade handling surface having a first side portion that defines a plane and a second side portion configured to receive the at least one shaving razor blade; and
wherein the cartridge is configured to expose a cutting edge of the at least one shaving razor blade past the first side portion.

2. The shaving razor of claim 1, wherein the blade handling surface is configured to bias the razor blade upon installation.

3. The shaving razor of claim 1, wherein the blade retainer is configured to removably couple multiple razor blades.

4. The shaving razor of claim 3, wherein the blade handling surface is configured to bias the razor blades upon installation.

5. The shaving razor of claim 1, wherein the blade handling surface is configured to expose a non-cutting surface of the razor blade.

6. The shaving razor of claim 1, wherein the handle comprises a distal end and a proximal end, the distal end comprising two biased arms configured to couple to the cartridge.

7. The shaving razor of claim 6, wherein the cartridge is rotatably coupled to the biased arms.

8. A shaving razor, comprising:
a handle;
a cartridge coupled to the handle, the cartridge comprising blade corner guards, a first cartridge arm, and a second cartridge arm separated by a blade retainer configured to releasably fix at least one shaving razor blade thereto;
the blade retainer comprising a blade handling surface and a contact surface that defines a first plane, wherein a first side portion of the cartridge along the first plane is configured to expose a cutting edge of the at least one shaving razor blade past the first plane, a second side portion defining a second plane configured to receive the at least one shaving razor blade; and
wherein the blade handling surface contacts the at least one shaving razor blade upon installation and at least one blade corner guard configured to prevent contact with respective corners of the cutting edge of the shaving razor blade and cutting surface during use.

9. The shaving razor of claim 8, wherein the blade handling surface is configured to bend the razor blade upon installation.

10. The shaving razor of claim 8, wherein the blade retainer is configured to removably couple multiple razor blades.

11. The shaving razor of claim 10, wherein the blade handling surface is configured to bend the razor blades upon installation.

12. The shaving razor of claim 8, wherein the blade handling surface is configured to expose a non-cutting surface of the razor blade extending through the second plane.

13. The shaving razor of claim 8, wherein the handle comprises a distal end and a proximal end, the distal end comprising two biased arms configured to couple to the cartridge.

14. The shaving razor of claim 13, wherein the cartridge is rotatably coupled to the biased arms.

15. A method for installing and removing shaving razor blades in a shaving razor, comprising:
inserting a razor blade into a receiving end of a shaving razor cartridge;
exposing a cutting edge of the razor blade through the shaving razor cartridge;
bending the razor blade against a blade handling surface of the shaving razor cartridge to releasably couple the razor blade to the blade handling surface; and
removing the razor blade by pulling out the razor blade through the receiving end of the shaving razor cartridge.

16. The method for installing and removing shaving razor blades in a shaving razor of claim 15, wherein the razor blade when bending, snaps against the blade handling surface.

17. The method for installing and removing shaving razor blades in a shaving razor of claim 15, further comprising gripping a non-cutting edge of the razor blade when removing.

18. The method for installing and removing shaving razor blades in a shaving razor of claim 15, using the razor blade until a cutting edge is no longer usable before removing.

19. The method for installing and removing shaving razor blades in a shaving razor of claim 15, further comprising inserting the razor blade into the receiving end of the shaving razor cartridge, the cartridge coupled to a handle, the shaving razor cartridge comprising blade corner guards, a first cartridge arm, and a second cartridge arm separated by a blade retainer configured to releasably fix at least one shaving razor blade thereto; the blade retainer comprising a blade handling surface and a contact surface that defines a first plane, wherein a first side portion of the cartridge along the first plane is configured to expose a cutting edge of the at least one shaving razor blade past the first plane, and a second side portion defining a second plane configured to receive the at least one shaving razor blade.

20. The method for installing and removing shaving razor blades in a shaving razor of claim 15, further comprising inserting a second razor blade into the receiving end of the shaving razor cartridge.
